(19) United States
(12) Patent Application Publication
(10) Pub. No.: US 2024/0051750 A1
(43) Pub. Date: Feb. 15, 2024

(54) MOBILE STORAGE SYSTEM HANDLING STORAGE DEVICES ON A FLOOR AREA

(71) Applicant: WHEEL.ME AS, Oslo (NO)

(72) Inventor: Atle TIMENES, Snarøya (NO)

(21) Appl. No.: 18/278,069

(22) PCT Filed: Feb. 17, 2022
(86) PCT No.: PCT/EP2022/053963

§ 371 Date: Aug. 21, 2023

(30) Foreign Application Priority Data
Feb. 26, 2021 (NO) 20210270

(51) Int. Cl. B65G 1/04

(52) U.S. Cl. CPC B65G 1/0478; B65G 1/0492

(57) ABSTRACT

A storage system handling storage devices on a floor area while occupying minimal floorspace, comprising a set of transportation assemblies, each adapted for conveying one or more storage devices, and arranged together in a two-dimensional compact puzzle-based configuration. Each transportation assembly comprises a transportation body, at least four autonomous rolling devices connected to the transportation body, each rolling device comprises driving means, communication means, and sensors for autonomous operation when controlled by a central controller unit comprised in the storage system, where the central control unit comprises a computer program product for arranging and re-arranging the set of transportation assemblies in the two-dimensional compact puzzle-based configuration according to position information of each transportation body stored in a database connected to the central control unit and control commands transmitted to the rolling devices.

### TECHNICAL FIELD

The present invention relates to a storage system and method for storing items, and more specifically to a mobile storage system for handling storage devices on a floor area while occupying minimal floorspace.

### BACKGROUND

Storing goods require allocation of space. Real estate is a limited commodity and real estate prices are increasing in areas closer to the cities where people live. At the same time companies wish to reduce lead times, especially in online retailing. Higher costs associated with required area for storage combined with rapid retrieval pose a challenge, especially for small and medium sized stores. Usually, inventory management is a trade-off between compact storage and accessibility of goods.

Another aspect is that order picking activities are very labour intensive. Order picking typically represents 55% of all operating costs in a typical warehouse. This has motivated picking systems where inventory is carried by a robot to a picker at a picking station instead of a picker using much time on transportation between shelves for picking inventory.

Today there are different largescale storage systems where storage containers are stacked and stored in columns in a grid structure. Storage containers are picked and handled by robots, running on top of the grid structure, and delivered to a picking station. Such systems are expensive and suited for large scale storage.

There are also storage systems intended for smaller scale storage, typically where the storage area is limited. Example of such are robotic mobile fulfilment systems and puzzle-based storage systems based on mobile platforms transporting payload. Puzzle-based storage systems are inspired by the famous game 15-puzzle where the objective is to arrange 15 numbered tiles in a 4×4 grid in sequence with only one empty slot that allows adjacent tiles of the empty slot to slide.

WO 03068657 A2 describes an example of a puzzle-based storage system based on moving platforms running on wheels for handling payloads such as palletized and containerized items. Each platform comprises several complex mechanical parts.

WO 9831579 A1 describes an example of a robotic system with automated pallets running on tracks. In this solution tracks must be installed in the area where pallets are operating, and the pallets cannot move outside tracks.

Prior art systems for conveying storage devices on a floor area are relatively complex and expensive. If a moving platform is broken, the whole platform must be replaced.

The present invention alleviates the drawbacks of prior art systems by providing a more flexible and cost-effective solution.

### SUMMARY OF THE INVENTION

Wheel.me has recently developed robotic technology enabling autonomously driven wheels. The present invention combines puzzle-based moving platforms enabled by autonomous wheels to make a storage system that is both compact, flexible, and cost effective.

The present invention is defined by a storage system adapted for handling storage devices on a floor area while occupying minimal floorspace. The storage system comprises a set of transportation assemblies, where each transportation assembly is adapted for conveying one or more storage devices, where the set of transportation assemblies is arranged together in a two-dimensional compact puzzle-based configuration.

Each transportation assembly comprises a transportation body, interface elements mounted on the transportation bodies, each interface element is adapted for receiving and connecting an autonomous rolling device, where at least four autonomous rolling devices are connected to each transportation body. Each rolling device comprises driving means, communication means, and sensors for autonomous operation when controlled by a central controller unit comprised in the storage system.

The central control unit comprises a computer program product for arranging and re-arranging positions of each transportation assembly in the set of transportation assemblies in the two-dimensional compact puzzle-based configuration according to position information of each transportation body is stored in a database connected to the central control unit and control commands transmitted to the rolling devices.

Further features of the storage system are defined in the claims.

The invention is further defined by a method for providing a storage system handling storage devices on a floor area while occupying minimal floorspace. The method comprises providing a set of transportation assemblies, each adapted for conveying a storage device, and arranging the transportation assemblies together in a two-dimensional compact puzzle-based configuration.

The method is further defined by providing each transportation assembly by mounting interface elements on a transportation body, each interface element being adapted for receiving and connecting an autonomous rolling device, connecting at least four autonomous rolling devices to each transportation body, each rolling device comprises driving means, communication means, and sensors for being autonomously driven and controlled, and providing a central controller unit with a computer program product for controlling movements of each transportation assembly by transmitting control commands according to received input instructions, and arranging and re-arranging positions of each transportation assembly in the set of transportation assemblies in the two-dimensional compact puzzle-based configuration according to position information of each transportation body stored in a database connected to the central control unit and control commands transmitted to the rolling devices.

Further features of the method are defined in the claims.

The invention is also defined by a computer program product that when executed on a central control unit controls movements of autonomously operating rolling devices connected to transportation bodies, together making transportation assemblies of a storage system. The transportation assemblies are arranged as a set of transportation assemblies in a two-dimensional compact puzzle-based configuration, and where movements of the autonomously operating rolling devices are controlled by the computer program according to position information stored in a database and input commands received from a control device.

### BRIEF DESCRIPTION OF THE DRAWINGS

The invention will now be described in more detail by reference to the accompanying figures.

FIG. 1 illustrates an example of a storage system with storage devices placed on transportation assemblies.

FIG. 2 shows a two-dimensional puzzle-based configuration with a set of transportation assemblies.

FIG. 3 shows an example of a transportation body comprised in a transportation assembly.

FIG. 4 shows another example of a transportation body comprised in a transportation assembly.

FIG. 5 illustrates communication between rolling devices of a transportation assembly and a central control unit.

### DETAILED DESCRIPTION

The present invention concerns a storage system handling storage devices occupying minimal floor space.

The storage system is made by providing a set of transportation assemblies, where each transportation assembly is adapted for conveying a storage device. The transportation assemblies are arranged together in a two-dimensional compact puzzle-based configuration and provided with at least four autonomously driven rolling devices connected to the transportation body. Each rolling device is given a unique ID. In this way, all rolling devices can receive unique movement instructions as well as transmit individual status information.

A central controller unit transmits control commands to the rolling devices for moving and rearranging positions of each transportation assembly in the set of transportation assemblies.

Rearranging of transportation assemblies is initiated by requesting a specific storage device at a delivery point. An algorithm in a central control unit is configured to provide an optimal route for the transportation assembly conveying the requested storage device through the puzzle-based configuration to reach the delivery point. The delivery point may be an accessible position at the border of the puzzle-based configuration, or it may be a determined location outside of the puzzle-based configuration. In this case, a transportation assembly with the requested storage device will leave the puzzle-based configuration and drive to the determined location.

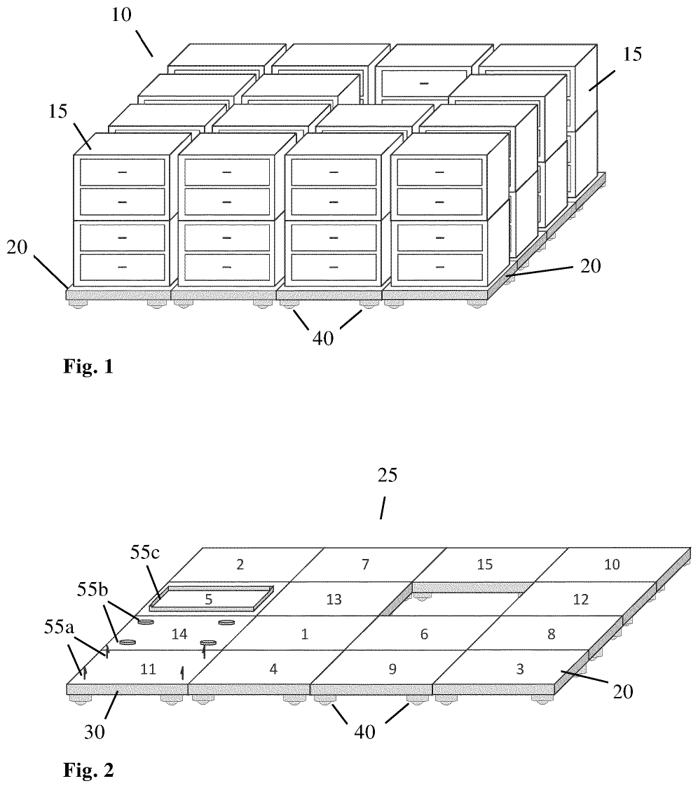

FIG. 1 illustrates an example of a storage system 10 with storage devices 15 placed on transportation assemblies 20 that are arranged as a set of transportation assemblies 20 in a two-dimensional compact puzzle-based configuration. By placing and keeping transportation assemblies 20 close together as shown in this example, minimal floorspace will be occupied.

The storage devices 15 placed on the transportation assemblies 20 can be any device for holding and storing items. Examples of such are bins, drawer systems, shelf-systems. These can be combined such that for instance a storage device 15 placed on a transportation assembly 20 is a combination of a shelf- and drawer-system.

FIG. 2 illustrates more clearly how the transportation assemblies 20 are placed in a two-dimensional configuration. As seen from the figure, one transportation assembly 20 is missing. This makes it possible to rearrange each transportation assembly 20 in the set of transportation assemblies 25 to all positions within the two-dimensional configuration. This is known as a puzzle-based configuration.

The figure illustrates a puzzle-based configuration with 15 numbered transportation assemblies in a 4×4 grid in sequence with only one empty slot that allows adjacent transportation assemblies to the empty slot to slide. The goal is to arrange the numbered transportation assemblies in a sequence by moving the tiles into the empty slot. How this sequence is established is well known from prior art puzzle-based systems and is not described further here.

Removing more than one transportation assembly 20 from the puzzle-based configuration makes it possible to move and rearrange more than one transportation assembly 20 at a time, thereby requiring less rearranging steps of transportation assemblies 20, resulting in faster access to a requested storage device 15. This may be advantageous for larger puzzle-based configurations comprising the autonomous transportation assemblies 20,

Storage devices 15 are preferably secured to the transportation assemblies 20 by connection means. The connection means can be any type of mechanism securing a storage device 15 in a fixed position on a transportation assembly 20. As an example, grippers 55a are mounted to a transportation assembly 20 for secure connection to the transportation assembly 20 and for holding storage devices 15 in fixed positions on the transportation assemblies 20. Other examples of connections means are screws, magnets 55b or a frame 55c mounted to a transportation assembly 20 for holding storage a device 15 in place.

According to the invention, a transportation assembly 20 comprises a transportation body 30 and at least four autonomous rolling devices 40 connected to the transportation body 30. Each rolling device 40 is autonomously controlled.

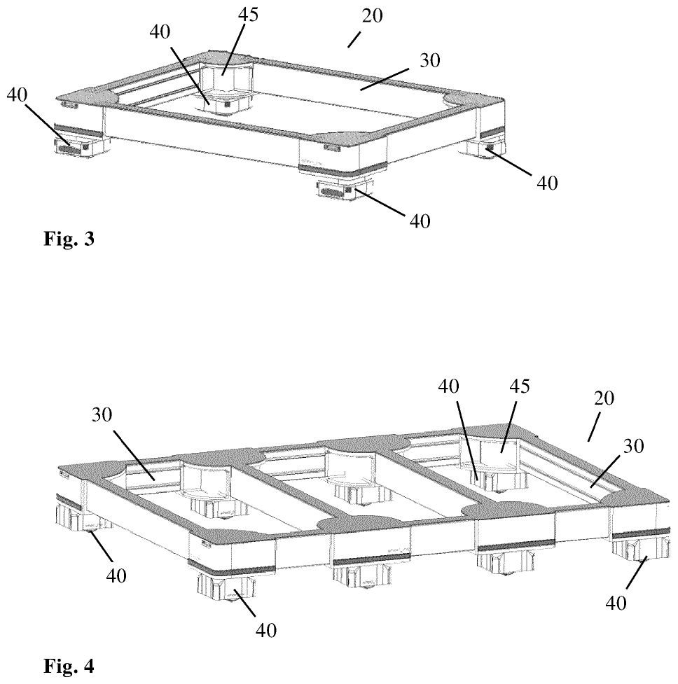

FIG. 3 shows an example of a transportation body 30 where a rolling device 40 is connected to the transportation assembly 20 at each corner of a rectangular shaped transportation body 30. By connecting the autonomous rolling devices 40 to each corner of an object such as a transportation body 30, the transportation body 30 can move autonomously by itself independent of external robots transporting the transportation body 30, and without transportation bodies comprising complex mechanical parts and driving means.

FIG. 4 shows another example of a transportation body 30. In this embodiment, eight rolling devices 40 are connected to a transportation body 30. This configuration a suited for handling heavier loads. For handling even heavier loads, a version with twelve rolling devices 40 is feasible.

For the different configurations of transportation bodies with four, eight and twelve rolling devices, only four autonomous rolling devices 40 are necessary, e.g. in each corner of the transportation body 30 providing driving forces in each direction when installed in a puzzle-based configuration. Further rolling devices can be passive devices without the autonomous means.

In one embodiment, the transportation bodies 30 comprises interface elements 45 adapted for connecting and disconnecting each rolling device 40 to the transportation bodies 30. The interface elements 45 can for instance be a click-on pull-out type for easy replacement of rolling devices 40 if necessary.

More details of the transportation bodies 30 and interface elements 45 are described in patent application NO 20201025, which is hereby included as a reference.

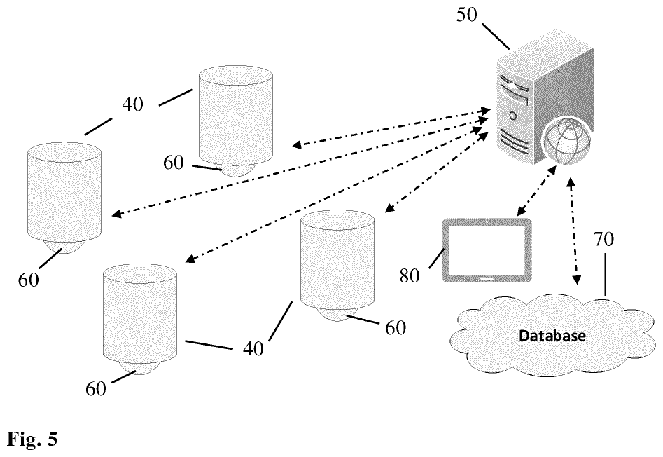

FIG. 5 illustrates communication between autonomous rolling devices 40 of a transportation assembly 20 and a central control unit 50, which is comprised in the storage system 10, for controlling movements of each rolling device 40 and thus a connected transportation assembly 20. Controlling movements of each rolling device 40 is feasible since each rolling device 40 comprises power means, driving means, communication means, and sensors for being autonomously controlled by the central controller unit 50. The rolling device 40 can rotate 360 degrees around its own axis, allowing it to drive in any direction. Furthermore, it can use input from the sensors and machine learning algorithms to sense the environment. Control of the rolling devices 40 can be done through a cloud computing system that can coordinate multiple rolling devices 40.

Example of an autonomous rolling device 40 comprising driving and communication means as well power supply means is described in applicant's patent EP 3355148 B1, which is hereby included as a reference. Each rolling device 40 comprises a rolling element 60, e.g. a wheel, which can be in a fixed position located at the end of a housing of the rolling device 40, typically the lower end of the housing when in an installed position as connected to the transportation body 30 to be moved. In an alternative version, the roller device 40 may be movably arranged in the housing between an upper and lower position. The upper, retracted position is a passive stationary position where the rolling element 60 is retracted in the rolling device 40, and the lower position is an extracted active position for moving the rolling element 60 along a surface, e.g. a floor area. The power supply is typically a rechargeable battery.

The central control unit 50 comprises a computer program product and communication means for controlling movements of each rolling device 40 for arranging and re-arranging positions of each transportation assembly 20 in the set of transportation assemblies 20 in the two-dimensional compact puzzle-based configuration according to position information of each transportation body 30 stored in a database 70 connected to the central control unit 50 and control commands transmitted to the rolling devices 40. The central control unit 50 is further connected to a control device 80.

Various devices for controlling a rolling element 60 can be arranged in the housing of a rolling device 40, including wireless receiver and control electronics. The wireless receiver and the control electronics is signally connected to each other, and the receiver is arranged for receiving wireless control signals from the central control unit 50.

To move a transportation assembly 20 in the two-dimensional compact puzzle-based configuration, its current position must be known. The current position may be its position relative to other transportation assemblies 20 in the puzzle-based configuration or its position relative to a floor area its being operating on.

There are different ways of detecting and acquiring the position of a rolling device 40. One way is by using internal means, e.g. motion detection sensors, installed in the rolling device 40. Another way is by using external means such as a camera or by using Lidar for measuring the distance from a reference point to the rolling device 40. Another example is to use an RFID chip connected to the rolling device 40 or to the device to be moved, i.e. the transportation assembly 30. Yet another way is by using ultrasound transmitter or a Bluetooth transmitter connected to the rolling device 40 for determining the position of the rolling device 40. Accurate position can then be found by means of triangulation.

Internal sensors and position detection devices keep track of the position of a rolling device 40 in the area it is operating in. Wheel encoders and inertial measurement units (IMU) can be used as motion detection sensors and odometry can be used for determining a current position based on generated data from the sensors.

Wheel encoders are used to detect rotation of the rolling element 60 enabling estimation of the distance travelled from a starting position. An IMU is used for estimating the orientation of the rolling device element and thus the direction/angle.

Odometry is used to estimate change in position over time based on the data generated from the wheel encoders and IMU sensors. In this way the current position of a rolling device 40 relative to a starting location can be estimated. The current position of the rolling device can be calculated by using a previously determined position, direction, and travelled distance. This is known as Dead Reckoning.

A more accurate method for determining the position of a rolling device 40 is achieved by combining said internal method with an external method for determining position. By combining data from various navigation systems having different physical principles one can increase the accuracy and robustness of the overall solution. By combining physical and mathematical methods, problems related to noise and drift can be alleviated. One may for instance combine Inertial Measurement Unit (IMU and wheel IMU) and Monocular Camera Simultaneous localization and mapping (SLAM).

For determining distance between rolling devices 40, Ultra-wideband (UWB) chip integrated in each rolling device 40 can be used. UWB is a radio technology requiring very low energy that is used for short-range communication. Signals from rolling devices 40 can be detected once they are for instance 12 cm from each other. The sensitivity of detection can be set and thus the accurate distance between rolling devices when detection occurs.

Combining sensor data derived from separate sources is known as Sensor Fusion, where the resulting data has less uncertainty than would be possible when the sources were used individually.

Since not all sensors are identical and further generate some noise, the noise and variances can be modeled, and the noise can be combined into the Kalman filter to reduce the noise and enhance the accuracy of the odometry. First, camera odometry and relative angle, i.e. travelling direction of the rolling device 40, derived from IMU are fused via Kalman filtering to get the best angle. At the same time, wheel encoders are fused together with wheel rotation given by wheel IMU to get the best translational distance driven. After that, the output from the two methods will be fused to get a final filtered overall odometry resulting in a more precise determination of the position of a rolling device 40.

The database 70 connected to the central control server 50 can be a local database 70 installed in the central control server 50 or a remote located database 70 connected to the central control server 50 via the World Wide Web, i.e. a cloud computing system. The database store position information for each transportation assembly 20 comprised in the storage system.

As an example, in a storage system comprising a total of 16 transportation assemblies 20 set up in a puzzle-based configuration of 4×4, each position occupied by a transportation assembly 20 within the 4×4 floor area is given x,y-coordinates, i.e. 1.1, 1.2, . . . 4.3, 4.4. Each transportation assembly 20 is given a unique identity and position. This identity and position information is stored in the database 70 and used for rearranging transportation assemblies 20 according to instructions transmitted from the central control unit 50 to the rolling devices 50. The instructions may be in the form of a sequence listing the order the different transportation assemblies shall move and in which direction. The sequence will depend on a current position of a requested storage device 15 and its transportation assembly 20 as well as a determined delivery point. The request is controlled from a control device 80.

In one embodiment, a selected autonomous rolling device 40 is set to act as a master device controlling the movements of the other rolling devices 40 connected to the transportation assembly 20 to be moved. The other rolling devices 40 will then act as slave devices and respond to instructions from the master device. The master device will then set up a specific moving pattern for the slave devices according to received control signals from the central control server 50 and transmit control signals to the slave devices instructing them to follow the movements of the master device.

Instructions transmitted to the rolling devices 40 from the central control unit 50 can as mentioned be controlled from a control device 80, such as a PC or tablet communicating with the central control device 50.

The control device 80 will run software keeping track of storage devices 15 and which storage device 15 to be accessed at a delivery point can be controlled by input commands. A more complex system can keep track of which items that are stored in each storage device 15 and a user can search for and select an item to be retrieved. This requires that items stored in a storage device 15 are linked to the storage device 15 and/or its conveying transportation assembly 20, and that this information is registered in a database.

When a specific storage device 15 or an item stored is requested by for instance selecting it from a menu or from a visual presentation of the control device 80, all transportation assemblies 20 will rearrange positions until the requested storage device 15 is available at a defined delivery point, e.g. at an opening in a wall of a room adjacent to a room where the storage system 10 is installed.

Determining the present positions of the rolling devices 40 and thus the x,y—positions of the transportation assemblies 20, is vital for seamless re-arranging of positions of the transportation assemblies 20.

As mentioned above, there are different methods for determining positions of rolling devices 40. One way is for instance by using a camera installed above a storage system 10 according to the invention. Movements and positions of each transportation assembly 20 can then be recorded and x,y position information can be deduced by video tracking software running in the central control unit 50.

As mentioned, another way of determining position information of a transportation assembly 20 is to let internal means in the rolling device 40 determine its position and transmit it to the central control server 50 together with its unique identification. In this case the identity of rolling devices 40 connected to each identified transportation assembly 20 is registered in the database 70. From position information transmitted from the rolling devices 40, the central control unit 50 can calculate x, y-positions.

The central control unit 50 of the storage system 10 runs a computer program product that when executed controls movements of the autonomously operating rolling devices 40 connected to transportation bodies 30. Movements are controlled according to updated position information of the rolling devices 40 and input commands received from a control device 80, e.g. a tablet.

From the control device 80, the configuration of the storage system can be set up and monitored. When setting up the system, the number of operating transportation assemblies 20 is registered as well as the configuration of the storage system 10, e.g. the layout of a square or rectangle formation of the set of transportation assemblies 20. Monitoring will include detection and warning of malfunctioning rolling devices 40 or low battery indication.

Batteries may be charged wirelessly, for instance by inductive means installed in the floor where the roller devices 40 are operating. This enables continuous charging of batteries. This solution may also provide continuous power supply to autonomous rolling devices 40 without batteries. In this embodiment inductive power supply provided to an autonomous rolling device 40 may run through a capacitor of the autonomous rolling device 40 for buffering power to ensure that the driving and communication means is provided with continuous power supply. Batteries of autonomously operating rolling devices 40 may also be charged by letting a transportation assembly 20 leave a puzzle-based configuration to interact with a charging station nearby upon detection. Near field communication (NFC) can be used as means for detection. This may be implemented by NFC tape attached to the autonomous rolling devices 40. When the charging station detects the NFC tape, it will be activated and provide power for charging the autonomous rolling devices 40.

The storage system 10 described herein is suited to be used in smaller installations, e.g. in a small storage room, in a garage, inside a truck etc. Due to its relatively simple construction, it is cost effective relative to similar prior art systems. It is further very simple to replace rolling devices 40 if necessary. The storage system 10 can easily be reconfigured by adding or removing transportation assemblies 20. The type of storage devices 15 placed on the transportation assemblies 20 can easily be changed and reconfigured according to need and physical restraints of the room where it is to operate.

1. A storage system handling storage devices on a floor area while occupying minimal floorspace, comprising a set of transportation assemblies, each adapted for conveying one or more storage devices, and arranged together in a two-dimensional compact puzzle-based configuration,
wherein
each transportation assembly comprises a transportation body, interface elements mounted on the transportation bodies,
each interface element is adapted for receiving and connecting an autonomous rolling device,
where at least four autonomous rolling devices are connected to the transportation body, each rolling device comprises driving means, communication means, and sensors for autonomous operation when controlled by a central controller unit comprised in the storage system, where the central controller unit comprises a computer program product for arranging and re-arranging positions of each transportation assembly in the set of transportation assemblies in the two-dimensional compact puzzle-based configuration according to position information of each transportation body stored in a database connected to the central control unit and control commands transmitted to the rolling devices.

2. The storage system according to claim 1, where a storage device is one or more containers, shelf-systems, or a combination of these.

3. The storage system according to claim 1, where the transportation body comprises connection means for securing the storage device to the transportation body.

4. The storage system according to claim 1, further comprising a control device connected to the central control unit.

5. A method for providing a storage system handling storage devices on a floor area while occupying minimal floorspace, by providing a set of transportation assemblies, each adapted for conveying a storage device, arranging the transportation assemblies together in a two-dimensional compact puzzle-based configuration,
wherein
providing each transportation assembly by mounting interface elements on a transportation bod, each interface element being adapted for receiving and connecting an autonomous rolling device, connecting at least four autonomous rolling devices to each transportation body, each rolling device comprises driving means, communication means, and sensors for being autonomously driven and controlled;
providing a central controller unit with a computer program product for controlling movements of each transportation assembly by transmitting control commands according to received input instructions;
arranging and re-arranging positions of each transportation assembly in the set of transportation assemblies in the two-dimensional compact puzzle-based configuration according to position information of each transportation body stored in a database connected to the central control unit and control commands transmitted to the rolling devices.

6. The method according to claim 5, characterized in providing one or more containers, shelf-systems, or a combination of these as the storage devices conveyed by the transportation assemblies.

7. The method according to 5, characterized in securing storage devices to transportation assembles by connection means provided on the transportation body.

8. The method according to claim 5, characterized in transmitting instructions to the central control unit from a control device connected to the central control unit.

9. A computer program product that when executed on a central control unit controls movements of autonomously operating rolling devices connected to transportation bodies, together making transportation assemblies of a storage system, the transportation assemblies are arranged as a set of transportation assemblies in a two-dimensional compact puzzle-based configuration, and where movements of the autonomously operating rolling devices are controlled by the computer program according to position information stored in a database and input commands received from a control device.
